(19) United States
(12) Patent Application Publication
(10) Pub. No.: US 2001/0006741 A1
(43) Pub. Date: Jul. 5, 2001

(54) Organic electroluminescent device

(75) Inventors: Hitoshi Ishikawa, Tokyo (JP); Satoru Toguchi, Tokyo (JP); Hiroshi Tada, Tokyo (JP); Yukiko Morioka, Tokyo (JP); Atsushi Oda, Tokyo (JP)

Correspondence Address: Patent Group, Hutchins, Wheeler & Dittmar, 101 Federal Street, Boston, MA, 02110, US

(73) Assignee: NEC Corporation

(21) Appl. No.: 09/736,091

(22) Filed: Dec. 13, 2000

(30) Foreign Application Priority Data
Dec. 13, 1999 (JP) 353676/1999

(51) Int. Cl. H05B 33/14

(52) U.S. Cl. 428/690; 428/704; 428/917; 313/504; 313/506

(57) ABSTRACT

An organic electroluminescent device comprising one or more organic thin film layer(s) placed between an anode and a cathode, at least one of said layer being a luminescent layer, the organic thin film layer containing a compound of formula [I]:

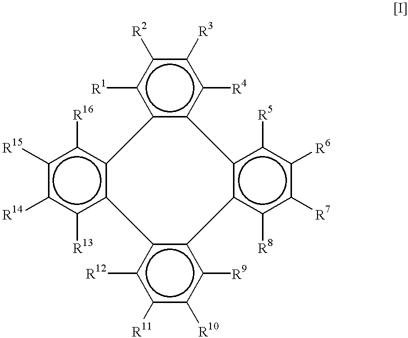

wherein R¹ to R¹⁶ are as specified in the specification.

### BACKGROUND OF THE INVENTION

1. Field of the Invention

The present invention relates to an organic electroluminescent device with excellent luminescence properties.

2. Discussion of Background

An organic electroluminescent device (which will hereinafter be called “organic EL device”) is a light-emitting device which makes use of the principle that when an electric field is applied, a fluorescent material emits light in response to the charge recombination of holes injected from an anode and electrons injected from a cathode. After C. W. Tang et al. of Eastman Kodak Company reported a low-voltage-driven organic EL device using a double layered structure (C. W. Tang, S. A. Vanslyke, Applied Physics Letters, Vol. 51, 913, (1987) and the like), studies on an organic EL device have been briskly carried out. Tang et al. reported an organic EL device using tris (8-hydroxyquinolinol aluminum) in a light-emitting layer and a triphenyldiamine derivative in a hole transporting layer. This stacked structure gives such advantages as an improvement in the injection efficiency of holes into the light-emitting layer; and confinement of the excitons into the light-emitting layer.

A double layered structure composed of a hole-injecting and transporting layer and an electron-transporting and light-emitting layer or a triple layered structure composed of a hole-injecting and transporting layer, a light-emitting layer and an electron-injecting and transporting layer is well known as an organic EL device. In order to increase the recombination efficiency of injected holes and electrons, various improvements in the device structure or fabrication process have been introduced to such multi-layered devices.

As a hole transporting material, triphenyl amine derivatives and aromatic diamine derivatives such as 4, 4′, 4″-tris (3-methylphenylphenylamino)-triphenyl amine which is a star burst molecule and N, N′-diphenyl-N, N′-bis (3-methylphenyl)-[1,1′-biphenyl]-4,4′-diamine are well known (for example, Patent Publications JP-A-8-20771, JP-A-8-40995, JP-A-8-40997, JP-A-8-53397, and JP-A-8-87122). As an electron transporting material, oxadiazole derivatives, triazole derivatives and the like are well known.

Chelate complexes such as tris (8-quinolinolate) aluminum complex, coumarin derivatives, tetraphenylbutadiene derivatives, bisstyrylarylene derivatives, oxadiazole derivatives and the like are know as light-emitting materials. Since various color lights in a visible region from blue to red are obtained from these light-emitting materials, there is increased expectation for industrialization of a full color organic EL device (refer to, e.g., JP-A-8-23965, JP-A-7-138561, and JP-A-3-200889).

Some organic EL devices with high luminance and long life have been reported or disclosed in recent years. However, the luminance and the life of such EL devices are not necessarily sufficient for practical use. Under such circumstances, there is an increasing demand for development of the materials capable of providing an organic EL device with high performance.

Technologies relating to the present invention are also disclosed in, e.g., Japanese Laid-Open Patent Application 11-251063, Japanese Patents 2,686,418 and 2,897,138.

### SUMMARY OF THE INVENTION

It is therefore a first object of the present invention to provide an organic EL device with high luminance and long life.

The inventors of the present invention have intensively examined the materials for constituting the organic EL device, and found that a compound having a tetraphenylene unit is effective when used in the organic EL device. Thus, the present invention has been accomplished.

Namely, the above-mentioned first object of the present invention can be achieved by an organic electroluminescent device comprising one or more organic thin film layer(s) placed between an anode and a cathode, at least one of said layer being a luminescent layer, the organic thin film layer comprising a compound represented by general formula [I]:

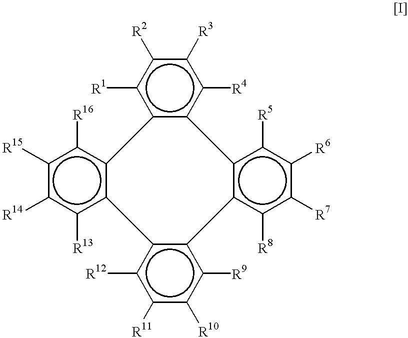

wherein each of R¹ to R¹⁶ independently represent a hydrogen atom, a halogen atom, hydroxyl group, a substituted or unsubstituted amino group, nitro group, cyano group, a substituted or unsubstituted alkyl group, a substituted or unsubstituted alkenyl group, a substituted or unsubstituted cycloalkyl group, a substituted or unsubstituted alkoxyl group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group, or carboxyl group, provided that at least one of R¹ to R¹⁶ is a group represented by -NAr¹Ar² wherein each of Ar¹ and Ar² independently represent a substituted or unsubstituted aryl group having 6 to 20 carbon atoms, and at least one of Ar¹ or Ar² has a substituted or unsubstituted styryl group, and that two of R¹ to R¹⁶ may form a ring.

It is desirable that at least one organic thin film layer comprising the above-mentioned compound of formula [I] be a light emitting layer.

At least one organic thin film layer comprising the above-mentioned compound of formula [I] may be a hole transporting layer.

At least one organic thin film layer comprising the above-mentioned compound of formula [I] may be an electron-transporting layer.

Further, an organic electroluminescent device comprising at least an anode, a luminescent zone and a cathode, the luminescent zone being formed one or more organic thin film layer(s), characterized in that luminescent zone is adjacent to the anode, and a layer adjacent to the anode of the organic layer(s) forming the luminescent zone contains a compound expressed in following general formula [I] in the form of a single substance or a mixture containing the same.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic cross sectional view showing one embodiment of an organic EL device according to the present invention.

FIG. 2 is a schematic cross sectional view showing another embodiment of an organic EL device according to the present invention.

FIG. 3 is a schematic cross sectional view showing another embodiment of an organic EL device according to the present invention.

FIG. 4 is a schematic cross sectional view showing still another embodiment of an organic EL device according to the present invention.

### DESCRIPTION OF THE PREFERRED EMBODIMENTS

The organic EL device of the present invention has such a structure that one or a plurality of organic thin film layers is interposed between an anode and a cathode. Further, at least one organic thin film layer comprises the above-mentioned compound represented by general formula [I].

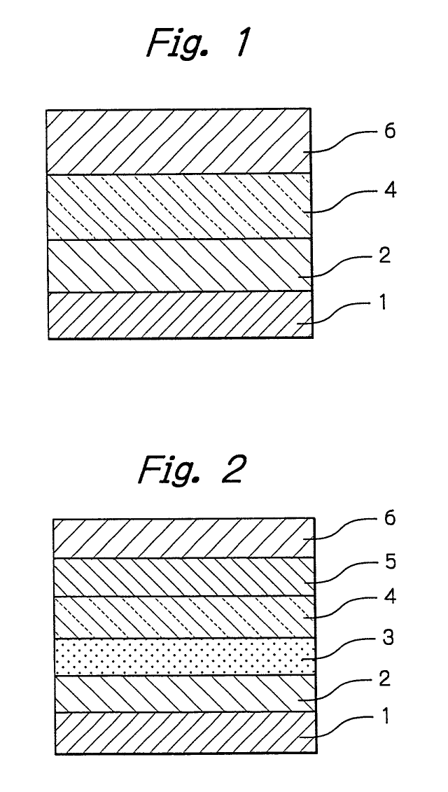

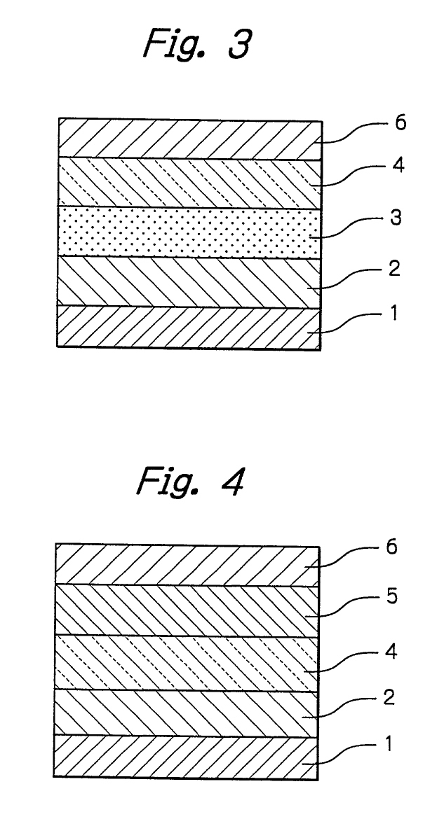

For example, an organic EL device illustrated in FIG. 1 comprises a substrate 1, and an anode 2, a light emitting layer 4 and a cathode 6 which are successively overlaid on the substrate 1 in this order. As shown in FIG. 2, an organic EL device is constructed in such a manner that an anode 2, a hole-transporting layer 3, a light emitting layer 4, an electron-transporting layer 5, and a cathode 6 are successively overlaid on a substrate 1 in this order. Further, an organic EL device of FIG. 3 has such a laminated structure that an anode 2, a hole-transporting layer 3, a light emitting layer 4, and a cathode 6 are successively overlaid on a substrate 1 in this order. Furthermore, an organic EL device shown in FIG. 4 comprises a substrate 1, and an anode 2, a light emitting layer 4, an electron-transporting layer 5 and a cathode 6 which are successively overlaid on the substrate 1 in this order.

Any of the organic thin film layers may comprise the above-mentioned compound of formula [I]. Further, the compound of formula [I] may be contained in any organic thin film layer in such a manner that a hole-transporting material, a light emitting material, or an electron-transporting material, which will be described later, is doped with the compound of formula (I).

The compound of formula [I] will now be explained in detail.

In formula [I], each of R¹ to R¹⁶ independently represent a hydrogen atom, a halogen atom, hydroxyl group, a substituted or unsubstituted amino group, nitro group, cyano group, a substituted or unsubstituted alkyl group, a substituted or unsubstituted alkenyl group, a substituted or unsubstituted cycloalkyl group, a substituted or unsubstituted alkoxyl group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group, or carboxyl group, provided that at least one of R¹ to R¹⁶ is a group represented by -NAr¹Ar² wherein each of Ar¹ and Ar² independently represent a substituted or unsubstituted aryl group having 6 to 20 carbon atoms, and at least one of Ar¹ or Ar² has a substituted or unsubstituted styryl group, and that two of R¹ to R¹⁶ may form a ring.

As the halogen atom, fluorine atom, chlorine atom, bromine atom, and iodine atom can be employed.

The above-mentioned substituted or unsubstituted amino group is represented by formula of -NX¹X², wherein X¹ and X² may be the same or different. Examples of X¹ and X² include a hydrogen atom, methyl group, ethyl group, propyl group, isopropyl group, n-butyl group, s-butyl group, isobutyl group, t-butyl group, n-pentyl group, n-hexyl group, n-heptyl group, n-octyl group, hydroxymethyl group, 1-hydroxyethyl group, 2-hydroxyethyl group, 2-hydroxyisobutyl group, 1,2-dihydroxyethyl group, 1,3-dihydroxyisopropyl group, 2,3-dihydroxy-t-butyl group, 1,2,3-trihydroxypropyl group, chloromethyl group, 1-chloroethyl group, 2-chloroethyl group, 2-chloroisobutyl group, 1,2-dichloroethyl group, 1,3-dichloroisopropyl group, 2,3-dichloro-t-butyl group, 1,2,3-trichloropropyl group, bromomethyl group, 1-bromoethyl group, 2-bromoethyl group, 2-bromoisobutyl group, 1,2-dibromoethyl group, 1,3-dibromoisopropyl group, 2,3-dibromo-t-butyl group, 1,2,3-tribromopropyl group, iodomethyl group, 1-iodoethyl group, 2-iodoethyl group, 2-iodoisobutyl group, 1,2-diiodoethyl group, 1,3-diiodoisopropyl group, 2,3-diiodo-t-butyl group, 1,2,3-triiodopropyl group, aminomethyl group, 1-aminoethyl group, 2-aminoethyl group, 2-aminoisobutyl group, 1,2-diaminoethyl group, 1,3-diaminoisopropyl group, 2,3-diamino-t-butyl group, 1,2,3-triaminopropyl group, cyanomethyl group, 1-cyanoethyl group, 2-cyanoethyl group, 2-cyanoisobutyl group, 1,2-dicyanoethyl group, 1,3-dicyanoisopropyl group, 2,3-dicyano-t-butyl group, 1,2,3-tricyanopropyl group, nitromethyl group, 1-nitroethyl group, 2-nitroethyl group, 2-nitroisobutyl group, 1,2-dinitroethyl group, 1,3-dinitroisopropyl group, 2,3-dinitro-t-butyl group, 1,2,3-trinitropropyl group, phenyl group, 1-naphthyl group, 2-naphthyl group, 1-anthryl group, 2-anthryl group, 9-anthryl group, 1-phenanthryl group, 2-phenanthryl group, 3-phenanthryl group, 4-phenanthryl group, 9-phenanthryl group, 1-naphthacenyl group, 2-naphthacenyl group, 9-naphthacenyl group, 4-styrylphenyl group, 1-pyrenyl group, 2-pyrenyl group, 4-pyrenyl group, 2-biphenylyl group, 3-biphenylyl group, 4-biphenylyl group, p-terphenyl-4-yl group, p-terphenyl-3-yl group, p-terphenyl-2-yl group, m-terphenyl-4-yl group, m- terphenyl-3-yl group, m-terphenyl-2-yl group, o-tolyl group, m-tolyl group, p-tolyl group, p-t-butylphenyl group, p-(2-phenylpropyl)phenyl group, 3-methyl-2-naphthyl group, 4-methyl-1-naphthyl group, 4-methyl-1-anthryl group, 4′-methylbiphenylyl group, 4″-t-butyl-p-terphenyl-4-yl group, 2-pyrrolyl group, 3-pyrrolyl group, pyrazinyl group, 2-pyridinyl group, 3-pyridinyl group, 4-pyridinyl group, 2-indolyl group, 3-indolyl group, 4-indolyl group, 5-indolyl group, 6-indolyl group, 7-indolyl group, 1-isoindolyl group, 3-isoindolyl group, 4-isoindolyl group, 5-isoindolyl group, 6-isoindolyl group, 7-isoindolyl group, 2-furyl group, 3-furyl group, 2-benzofuranyl group, 3-benzofuranyl group, 4-benzofuranyl group, 5-benzofuranyl group, 6-benzofuranyl group, 7-benzofuranyl group, 1-isobenzofuranyl group, 3-isobenzofuranyl group, 4-isobenzofuranyl group, 5-isobenzofuranyl group, 6-isobenzofuranyl group, 7-isobenzofuranyl group, 2-quinolyl group, 3-quinolyl group, 4-quinolyl group, 5-quinolyl group, 6-quinolyl group, 7-quinolyl group, 8-quinolyl group, 1-isoquinolyl group, 3-isoquinolyl group, 4-isoquinolyl group, 5-isoquinolyl group, 6-isoquinolyl group, 7-isoquinolyl group, 8-isoquinolyl group, 2-quinoxalinyl group, 5-quinoxalinyl group, 6-quinoxalinyl group, 1-carbazolyl group, 2-carbazolyl group, 3-carbazolyl group, 4-carbazolyl group, 1-phenanthridinyl group, 2-phenanthridinyl group, 3-phenanthridinyl group, 4-phenanthridinyl group, 6-phenanthridinyl group, 7-phenanthridinyl group, 8-phenanthridinyl group, 9-phenanthridinyl group, 10-phenanthridinyl group, 1-acridinyl group, 2-acridinyl group, 3-acridinyl group, 4-acridinyl group, 9-acridinyl group, 1,7-phenanthrolin- 2-yl group, 1,7-phenanthrolin-3-yl group, 1,7-phenanthrolin-4-yl group, 1,7-phenanthrolin-5-yl group, 1,7-phenanthrolin-6-yl group, 1,7-phenanthrolin-8-yl group, 1,7-phenanthrolin-9-yl group, 1,7-phenanthrolin-10-yl group, 1,8-phenanthrolin-2-yl group, 1,8-phenanthrolin-3-yl group, 1,8-phenanthrolin-4-yl group, 1,8-phenanthrolin-5-yl group, 1,8-phenanthrolin-6-yl group, 1,8-phenanthrolin-7-yl group, 1,8-phenanthrolin-9-yl group, 1,8-phenanthrolin-10-yl group, 1,9-phenanthrolin-2-yl group, 1,9-phenanthrolin-3-yl group, 1,9-phenanthrolin-4-yl group, 1,9-phenanthrolin-5-yl group, 1,9-phenanthrolin-6-yl group, 1,9-phenanthrolin-7-yl group, 1,9-phenanthrolin-8-yl group, 1,9-phenanthrolin-10-yl group, 1,10-phenanthrolin-2-yl group, 1,10-phenanthrolin-3-yl group, 1,10-phenanthrolin-4-yl group, 1,10-phenanthrolin-5-yl group, 2,9-phenanthrolin-1-yl group, 2,9-phenanthrolin-3-yl group, 2,9-phenanthrolin-4-yl group, 2,9-phenanthrolin-5-yl group, 2,9-phenanthrolin-6-yl group, 2,9-phenanthrolin-7-yl group, 2,9-phenanthrolin-8-yl group, 2,9-phenanthrolin-10-yl group, 2,8-phenanthrolin-1-yl group, 2,8-phenanthrolin-3-yl group, 2,8-phenanthrolin-4-yl group, 2,8-phenanthrolin-5-yl group, 2,8-phenanthrolin-6-yl group, 2,8-phenanthrolin-7-yl group, 2,8-phenanthrolin-9-yl group, 2,9-phenanthrolin-10-yl group, 2,7-phenanthrolin-1-yl group, 2,7-phenanthrolin-3-yl group, 2,7-phenanthrolin-4-yl group, 2,7-phenanthrolin-5-yl group, 2,7-phenanthrolin-6-yl group, 2,7-phenanthrolin-8-yl group, 2,7-phenanthrolin-9-yl group, 2,7-phenanthrolin-10-yl group, 1-phenazinyl group, 2-phenazinyl group, 1-phenothiazinyl group, 2-phenothiazinyl group, 3-phenothiazinyl group, 4-phenothiazinyl group, 1-phenoxazinyl group, 2-phenoxazinyl group, 3-phenoxazinyl group, 4-phenoxazinyl group, 2-oxazolyl group, 4-oxazolyl group, 5-oxazolyl group, 2-oxadiazolyl group, 5-oxadiazolyl group, 3-furazanyl group, 2-thienyl group, 3-thienyl group, 2-methylpyrrol-1-yl group, 2-methylpyrrol-3-yl group, 2-methylpyrrol-4-yl group, 2-methylpyrrol-5-yl group, 3-methylpyrrol-1-yl group, 3-methylpyrrol-2-yl group, 3-methylpyrrol-4-yl group, 3-methylpyrrol-5-yl group, 2-t-butylpyrrol-4-yl group, 3- (2-phenyipropyl) pyrrol-1-yl group, 2-methyl-1-indolyl group, 4-methyl-5-indolyl group, 2-methyl-3-indolyl group, 4-methyl-3-indolyl group, 2-t-butyl-1-indolyl group, 4-t-butyl-1-indolyl group, 2-t-butyl-3-indolyl group, and 4-t-butyl-3-indolyl group.

Examples of the above-mentioned substituted or unsubstituted alkyl group include methyl group, ethyl group, propyl group, isopropyl group, n-butyl group, s-butyl group, isobutyl group, t-butyl group, n-pentyl group, n-hexyl group, n-heptyl group, n-octyl group, hydroxymethyl group, 1-hydroxyethyl group, 2-hydroxyethyl group, 2-hydroxyisobutyl group, 1,2-dihydroxyethyl group, 1,3-dihydroxyisopropyl group, 2,3-dihydroxy-t-butyl group, 1,2,3-trihydroxypropyl group, chloromethyl group, 1-chloroethyl group, 2-chloroethyl group, 2-chloroisobutyl group, 1,2-dichloroethyl group, 1,3-dichloroisopropyl group, 2,3-dichloro-t-butyl group, 1,2,3-trichloropropyl group, bromomethyl group, 1-bromoethyl group, 2-bromoethyl group, 2-bromoisobutyl group, 1,2-dibromoethyl group, 1,3-dibromoisopropyl group, 2,3-dibromo-t-butyl group, 1,2,3-tribromopropyl group, iodomethyl group, 1-iodoethyl group, 2-iodoethyl group, 2-iodoisobutyl group, 1,2-diiodoethyl group, 1,3-diiodoisopropyl group, 2,3-diiodo-t-butyl group, 1,2,3-triiodopropyl group, aminomethyl group, 1-aminoethyl group, 2-aminoethyl group, 2-aminoisobutyl group, 1,2-diaminoethyl group, 1,3-diaminoisopropyl group, 2,3-diamino-t-butyl group, 1,2,3-triaminopropyl group, cyanomethyl group, 1-cyanoethyl group, 2-cyanoethyl group, 2-cyanoisobutyl group, 1,2-dicyanoethyl group, 1,3-dicyanoisopropyl group, 2,3-dicyano-t-butyl group, 1,2,3-tricyanopropyl group, nitromethyl group, 1-nitroethyl group, 2-nitroethyl group, 2-nitroisobutyl group, 1,2-dinitroethyl group, 1,3-dinitroisopropyl group, 2,3-dinitro-t-butyl group, and 1,2,3-trinitropropyl group.

Examples of the above-mentioned substituted or unsubstituted alkenyl group include vinyl group, allyl group, 1-butenyl group, 2-butenyl group, 3-butenyl group, 1,3-butanedienyl group, 1-methylvinyl group, styryl group, 4-diphenylaminostyryl group, 4-di-p-tolylaminostyryl group, 4-di-m-tolylaminostyryl group, 2,2-diphenylvinyl group, 1,2-diphenylvinyl group, 1-methylallyl group, 1,1-dimethylallyl group, 2-methylallyl group, 1-phenylallyl group, 2-phenylallyl group, 3-phenylallyl group, 3,3-diphenylallyl group, 1,2-dimethylallyl group, 1-phenyl-1-butenyl group, and 3-phenyl-1-butenyl group.

Examples of the above-mentioned substituted or unsubstituted cycloalkyl group include cyclopropyl group, cyclobutyl group, cyclopentyl group, cyclohexyl group, and 4-methylcyclohexyl group.

The above-mentioned substituted or unsubstituted alkoxyl group is represented by formula of -OY. Examples of Y in the above-mentioned formula include ethyl group, propyl group, isopropyl group, n-butyl group, s-butyl group, isobutyl group, t-butyl group, n-pentyl group, n-hexyl group, n-heptyl group, n-octyl group, hydroxymethyl group, 1-hydroxyethyl group, 2-hydroxyethyl group, 2-hydroxyisobutyl group, 1,2-dihydroxyethyl group, 1,3-dihydroxyisopropyl group, 2,3-dihydroxy-t-butyl group, 1,2,3-trihydroxypropyl group, chloromethyl group, 1-chloroethyl group, 2-chloroethyl group, 2-chloroisobutyl group, 1,2-dichloroethyl group, 1,3-dichloroisopropyl group, 2,3-dichloro-t-butyl group, 1,2,3-trichloropropyl group, bromomethyl group, 1-bromoethyl group, 2-bromoethyl group, 2-bromoisobutyl group, 1,2-dibromoethyl group, 1,3-dibromoisopropyl group, 2,3-dibromo-t-butyl group, 1,2,3-tribromopropyl group, iodomethyl group, 1-iodoethyl group, 2-iodoethyl group, 2-iodoisobutyl group, 1,2-diiodoethyl group, 1,3-diiodoisopropyl group, 2,3-diiodo-t-butyl group, 1,2,3-triiodopropyl group, aminomethyl group, 1-aminoethyl group, 2-aminoethyl group, 2-aminoisobutyl group, 1,2-diaminoethyl group, 1,3-diaminoisopropyl group, 2,3-diamino-t-butyl group, 1,2,3-triaminopropyl group, cyanomethyl group, 1-cyanoethyl group, 2-cyanoethyl group, 2-cyanoisobutyl group, 1,2-dicyanoethyl group, 1,3-dicyanoisopropyl group, 2,3-dicyano-t-butyl group, 1,2,3-tricyanopropyl group, nitromethyl group, 1-nitroethyl group, 2-nitroethyl group, 2-nitroisobutyl group, 1,2-dinitroethyl group, 1,3-dinitroisopropyl group, 2,3-dinitro-t-butyl group, and 1,2,3-trinitropropyl group.

Examples of the above-mentioned substituted or unsubstituted aromatic hydrocarbon group include phenyl group, 1-naphthyl group, 2-naphthyl group, 1-anthryl group, 2-anthryl group, 9-anthryl group, 1-phenanthryl group, 2-phenanthryl group, 3-phenanthryl group, 4-phenanthryl group, 9-phenanthryl group, 1-naphthacenyl group, 2-naphtacenyl group, 9-naphthacenyl group, 1-pyrenyl group, 2-pyrenyl group, 4-pyrenyl group, 2-biphenylyl group, 3-biphenylyl group, 4-biphenylyl group, p-terphenyl-4-yl group, p-terphenyl-3-yl group, p-terphenyl-2-yl group, m-terphenyl-4-yl group, m-terphenyl-3-yl group, m-terphenyl-2-yl group, o-tolyl group, m-tolyl group, p-tolyl group, p-t-butylphenyl group, p-(2-phenylpropyl)phenyl group, 3-methyl-2-naphthyl group, 4-methyl-1-naphthyl group, 4-methyl-1-anthryl group, 4′-methylbiphenylyl group, and 4″-t-butyl-p-terphenyl-4-yl group.

Examples of the above-mentioned substituted or unsubstituted aromatic heterocyclic group include 1-pyrrolyl group, 2-pyrrolyl group, 3-pyrrolyl group, pyrazinyl group, 2-pyridinyl group, 3-pyridinyl group, 4-pyridinyl group, 1-indolyl group, 2-indolyl group, 3-indolyl group, 4-indolyl group, 5-indolyl group, 6-indolyl group, 7-indolyl group, 1-isoindolyl group, 2-isoindolyl group, 3-isoindolyl group, 4-isoindolyl group, 5-isoindolyl group, 6-isoindolyl group, 7-isoindolyl group, 2-furyl group, 3-furyl group, 2-benzofuranyl group, 3-benzofuranyl group, 4-benzofuranyl group, 5-benzofuranyl group, 6-benzofuranyl group, 7-benzofuranyl group, 1-isobenzofuranyl group, 3-isobenzofuranyl group, 4-isobenzofuranyl group, 5-isobenzofuranyl group, 6-isobenzofuranyl group, 7-isobenzofuranyl group, 2-quinolyl group, 3-quinolyl group, 4-quinolyl group, 5-quinolyl group, 6-quinolyl group, 7-quinolyl group, 8-quinolyl group, 1-isoquinolyl group, 3-isoquinolyl group, 4-isoquinolyl group, 5-isoquinolyl group, 6-isoquinolyl group, 7-isoquinolyl group, 8-isoquinolyl group, 2-quinoxalinyl group, 5-quinoxalinyl group, 6-quinoxalinyl group, 1-carbazolyl group, 2-carbazolyl group, 3-carbazolyl group, 4-carbazolyl group, 9-carbazolyl group, 1-phenanthridinyl group, 2-phenanthridinyl group, 3-phenanthridinyl group, 4-phenanthridinyl group, 6-phenanthridinyl group, 7-phenanthridinyl group, 8-phenanthridinyl group, 9-phenanthridinyl group, 10-phenanthridinyl group, 1-acridinyl group, 2-acridinyl group, 3-acridinyl group, 4-acridinyl group, 9-acridinyl group, 1,7-phenanthrolin-2-yl group, 1,7-phenanthrolin-3-yl group, 1,7-phenanthrolin-4-yl group, 1,7-phenanthrolin-5-yl group, 1,7-phenanthrolin-6-yl group, 1,7-phenanthrolin-8-yl group, 1,7-phenanthrolin-9-yl group, 1,7-phenanthrolin-10-yl group, 1,8-phenanthrolin-2-yl group, 1,8-phenanthrolin-3-yl group, 1,8-phenanthrolin-4-yl group, 1,8-phenanthrolin-5-yl group, 1,7-phenanthrolin-6-yl group, 1,8-phenanthrolin-7-yl group, 1,8-phenanthrolin-9-yl group, 1,8-phenanthrolin-10-yl group, 1,9-phenanthrolin-2-yl group, 1,9-phenanthrolin-3-yl group, 1,9-phenanthrolin-4-yl group, 1,9-phenanthrolin-5-yl group, 1,9-phenanthrolin-6-yl group, 1,9-phenanthrolin-7-yl group, 1,9-phenanthrolin-8-yl group, 1,9-phenanthrolin-10-yl group, 1,10-phenanthrolin-2-yl group, 1,10-phenanthrolin-3-yl group, 1,10-phenanthrolin-4-yl group, 1,10-phenanthrolin-5-yl group, 2,9-phenanthrolin-1-yl group, 2,9-phenanthrolin-3-yl group, 2,9-phenanthrolin-4-yl group, 2,9-phenanthrolin-5-yl group, 2,9-phenanthrolin-6-yl group, 2,9-phenanthrolin-7-yl group, 2,9-phenanthrolin-8-yl group, 2,9-phenanthrolin-10-yl group, 2,8-phenanthrolin-1-yl group, 2,8-phenanthrolin-3-yl group, 2,8-phenanthrolin-4-yl group, 2,8-phenanthrolin-5-yl group, 2,8-phenanthrolin-6-yl group, 2,8-phenanthrolin-7-yl group, 2,8-phenanthrolin-9-yl group, 2,8-phenanthrolin-10-yl group, 2,7-phenanthrolin-1-yl group, 2,7-phenanthrolin-3-yl group, 2,7-phenanthrolin-4-yl group, 2,7-phenanthrolin-5-yl group, 2,7-phenanthrolin-6-yl group, 2,7-phenanthrolin-8-yl group, 2,7 -phenanthrolin-9-yl group, 2,7-phenanthrolin-10-yl group, 1-phenazinyl group, 2-phenazninyl group, 1-phenothiazinyl group, 2-phenothiazinyl group, 3-phenothiazinyl group, 4-phenothiazinyl group, 10-phenothiazinyl group, 1-phenoxazinyl group, 2-phenoxazinyl group, 3-phenoxazinyl group, 4-phenoxazinyl group, 10-phenoxazinyl group, 2-oxazolyl group, 4-oxazolyl group, 5-oxazolyl group, 2-oxadiazolyl group, 6-oxadiazolyl group, 3-furazanyl group, 2-thienyl group, 3-thienyl group, 2-methylpyrrol-1-yl group, 2-methylpyrrol-3-yl group, 2-methylpyrrol-4-yl group, 2-methylpyrrol-5-yl group, 3-methylpyrrol-1-yl group, 3-methylpyrrol-2-yl group, 3-methylpyrrol-4-yl group, 3-methylpyrrol-5-yl group, 2-t-butylpyrrol-4-yl group, 3-(2-phenylpropyl)pyrrol-1-yl group, 2-methyl-1-indolyl group, 4-methyl-1-indolyl group, 2-methyl-3-indolyl group, 4-methyl-3-indolyl group, 2-t-butyl-1-indolyl group, 4-t-butyl-1-indolyl group, 2-t-butyl-3-indolyl group, and 4-t-butyl-3-indolyl group.

Examples of the above-mentioned substituted or unsubstituted aralkyl group include benzyl group, 1-phenylethyl group, 2-phenylethyl group, 1-phenylisopropyl group, 2-phenylisopropyl group, phenyl-t-butyl group, α-naphthylmethyl group, 1-α-naphthylethyl group, 2-α-naphthylethyl group, 1-α-naphthylisopropyl group, 2-α-naphthylisopropyl group, β-naphthylmethyl group, 1-β-naphthylethyl group, 2-β-naphthylethyl group, 1-β-naphthylisopropyl group, 2-β-naphthylisopropyl group, 1-pyrrolylmethyl group, 2-(1-pyrrolyl)ethyl group, p-methylbenzyl group, m-methylbenzyl group, o-methylbenzyl group, p-chlorobenzyl group, m-chlorobenzyl group, o-chlorobenzyl group, p-bromobenzyl group, m-bromobenzyl group, o-bromobenzyl group, p-iodobenzyl group, m-iodobenzyl group, m-iodobenzyl group, o-iodobenzyl group, p-hydroxybenzyl group, m-hydroxybenzyl group, o-hydroxybenzyl group, p-aminobenzyl group, m-aminobenzyl group, o-aminobenzyl group, p-nitrobenzyl group, m-nitrobenzyl group, o-nitrobenzyl group, p-cyanobenzyl group, m-cyanobenzyl group, o-cyanobenzyl group, 1-hydroxy-2-phenylisopropyl group, and 1-chloro-2-phenylisopropyl group.

The above-mentioned substituted or unsubstituted aryloxy group is represented by formula of -OZ. Examples of Z in the above-mentioned formula include phenyl group, 1-naphthyl group, 2-naphthyl group, 1-anthryl group, 2-anthryl group, 9-anthryl group, 1-phenanthryl group, 2-phenanthryl group, 3-phenanthryl group, 4-phenanthryl group, 9-phenanthryl group, 1-naphthacenyl group, 2-naphthacenyl group, 9-naphthacenyl group, 1-pyrenyl group, 2-pyrenyl group, 4-pyrenyl group, 2-biphenylyl group, 3-biphenylyl group, 4-biphenylyl group, p-terphenyl-4-yl group, p-terphenyl-3-yl group, p-terphenyl-2-yl group, m-terphenyl-4-yl group, m-terphenyl-3-yl group, m-terphenyl-2-yl group, o-tolyl group, m-tolyl group, p-tolyl group, p-t-butylphenyl group, p-( 2-phenylpropyl)phenyl group, 3-methyl-2-naphthyl group, 4-methyl-1-naphthyl group, 4-methyl-1-anthryl group, 4′-methylbiphenylyl group, 4″-t-butyl-p-terphenyl-4-yl group, 2-pyrrolyl group, 3-pyrrolyl group, pyrazinyl group, 2-pyridinyl group, 3-pyridinyl group, 4-pyridinyl group, 2-indolyl group, 3-indolyl group, 4-indolyl group, 5-indolyl group, 6-indolyl group, 7-indolyl group, 1-isoindolyl group, 3-isoindolyl group, 4-isoindolyl group, 5-isoindolyl group, 6-isoindolyl group, 7-isoindolyl group, 2-furyl group, 3-furyl group, 2-benzofuranyl group, 3-benzofuranyl group, 4-benzofuranyl group, 5-benzofuranyl group, 6-benzofuranyl group, 7-benzofuranyl group, 1-isobenzofuranyl group, 3-isobenzofuranyl group, 4-isobenzofuranyl group, 5-isobenzofuranyl group, 6-isobenzofuranyl group, 7-isobenzofuranyl group, 2-quinolyl group, 3-quinolyl group, 4-quinolyl group, 5-quinolyl group, 6-quinolyl group, 7-quinolyl group, 8-quinolyl group, 1-isoquinolyl group, 3-isoquinolyl group, 4-isoquinolyl group, 5-isoquinolyl group, 6-isoquinolyl group, 7-isoquinolyl group, 8-isoquinolyl group, 2-quinoxalinyl group, 5-quinoxalinyl group, 6-quinoxalinyl group, 1-carbazolyl group, 2-carbazolyl group, 3-carbazolyl group, 4-carbazolyl group, 1-phenanthridinyl group, 2-phenanthridinyl group, 3-phenanthridinyl group, 4-phenanthridinyl group, 6-phenanthridinyl group, 7-phenanthridinyl group, 8-phenanthridinyl group, 9-phenanthridinyl group, 10-phenanthridinyl group, 1-acridinyl group, 2-acridinyl group, 3-acridinyl group, 4-acridinyl group, 9-acridinyl group, 1,7-phenanthrolin-2-yl group, 1,7-phenanthrolin-3-yl group, 1,7-phenanthrolin-4-yl group, 1,7-phenanthrolin-5-yl group, 1,7-phenanthrolin-6-yl group, 1,7-phenanthrolin-8-yl group, 1,7-phenanthrolin-9-yl group, 1,7-phenanthrolin-10-yl group, 1,8-phenanthrolin-2-yl group, 1,8-phenanthroin-3-yl group, 1,8-phenanthrolin-4-yl group, 1,8-phenanthrolin-5-yl group, 1,8-phenanthrolin-6-yl group, 1,8-phenanthrolin-7-yl group, 1,8-phenanthrolin-9-yl group, 1,8-phenanthrolin-10-yl group, 1,9-phenanthrolin-2-yl group, 1,9-phenanthrolin-3-yl group, 1,9-phenanthroin-4-yl group, 1,9-phenanthrolin-5-yl group, 1,9-phenanthrolin-6-yl group, 1,9-phenanthrolin-7-yl group, 1,9-phenanthrolin-8-yl group, 1,9-phenanthrolin-10-yl group, 1,10-phenanthrolin-2-yl group, 1,10-phenanthrolin-3-yl group, 1,10-phenanthrolin-4-yl group, 1,10-phenanthrolin-5-yl group, 2,9 -phenanthrolin-1-yl group, 2,9-phenanthrolin-3-yl group, 2,9-phenanthrolin-4-yl group, 2,9-phenanthrolin-5-yl group, 2,9-phenanthrolin-6-yl group, 2,9-phenanthrolin-7-yl group, 2,9-phenanthrolin-8-yl group, 2,9-phenanthrolin-10-yl group, 2,8-phenanthrolin-1-yl group, 2,8-phenanthrolin-3-yl group, 2,8-phenanthrolin-4-yl group, 2,8-phenanthrolin-5-yl group, 2,8-phenanthrolin-6-yl group, 2,8-phenanthrolin-7-yl group, 2,8-phenanthrolin-9-yl group, 2,8-phenanthrolin-10-yl group, 2,7-phenanthrolin-1-yl group, 2,7-phenanthrolin-3-yl group, 2,7-phenanthrolin-4-yl group, 2,7-phenanthrolin-5-yl group, 2,7-phenanthrolin-6-yl group, 2,7-phenanthrolin-10-yl group, 2,7-phenanthrolin-9-yl group, 2,7-phenanthrolin-1-yl group, 1-phenazinyl group, 2-phenazinyl group, 1- phenothiazinyl group, 2-phenothiazinyl group, 3-phenothiazinyl group, 4-phenothiazinyl group, 1-phenoxazinyl group, 2-phenoxazinyl group, 3-phenoxazinyl group, 4-phenoxazinyl group, 2-oxazolyl group, 4-oxazolyl group, 5-oxazolyl group, 2-oxadiazolyl group, 5-oxadiazolyl group, 3-furazanyl group, 2-thienyl group, 3-thienyl group, 3-thienyl group, 2-methylpyrrol-1-yl group, 2-methylpyrrol-3-yl group, 2-methylpyrrol-4-yl group, 2-methyhpyrrol-5-yl group, 3-methylpyrrol-1-yl group, 3-methylpyrrol-2-yl group, 3-methylpyrrol-4-yl group, 3-methylpyrrol-5-yl group, 2-t-butylpyrrol-4-yl group, 3-( 2-phenylpropyl)pyrrol-1-yl group, 2-methyl-1-indolyl group, 4-methyl-1-indolyl group, 2-methyl-3-indolyl group, 4-methyl-3-indolyl group, 2-t-butyl-1-indolyl group, 4-t-butyl-1-indolyl group, 2-t-butyl-3-indolyl group, and 4-t-butyl-3-indolyl group.

The above-mentioned substituted or unsubstituted alkoxycarbonyl group is represented by formula of -COOY. Examples of Y in the above-mentioned formula include methyl group, ethyl group, propyl group, isopropyl group, n-butyl group, s-butyl group, isobutyl group, t-butyl group, n-pentyl group, n-hexyl group, n-heptyl group, n-octyl group, hydroxymethyl group, 1-hydroxyethyl group, 2-hydroxyethyl group, 2-hydroxyisobutyl group, 1,2-dihydroxyethyl group, 1,3-dihydroxyisopropyl group, 2,3-dihydroxy-t-butyl group, 1,2,3-trihydroxypropyl group, chloromethyl group, 1-chloroethyl group, 2-chloroethyl group, 2-chloroisobutyl group, 1,2-dichloroethyl group, 1,3-dichloroisopropyl group, 2,3-dichloro-t-butyl group, 1,2,3-trichloropropyl group, bromomethyl group, 1-bromoethyl group, 2-bromoethyl group, 2-bromoisobutyl group, 1,2-dibromoethyl group, 1,3-dibromoisopropyl group, 2,3-dibromo-t-butyl group, 1,2,3-tribromopropyl group, iodomethyl group, 1-iodoethyl group, 2-iodoethyl group, 2-iodoisobutyl group, 1,2-diiodoethyl group, 1,3-diiodoisopropyl group, 2,3-diiodo-t-butyl group, 1,2,3-triiodopropyl group, aminomethyl group, 1-aminoethyl group, 2-aminoethyl group, 2-aminoisobutyl group, 1,2-diaminoethyl group, 1,3-diaminoisopropyl group, 2,3-diamino-t-butyl group, 1,2,3-triaminopropyl group, cyanomethyl group, 1-cyanoethyl group, 2-cyanoethyl group, 2-cyanoisobutyl group, 1,2-dicyanoethyl group, 1,3-dicyanoisopropyl group, 2,3-dicyano-t-butyl group, 1,2,3-tricyanopropyl group, nitromethyl group, 1-nitroethyl group, 2-nitroethyl group, 2-nitroisobutyl group, 1,2-dinitroethyl group, 1,3-dinitroisopropyl group, 2,3-dinitro-t-butyl group, and 1,2,3-trinitropropyl group.

Examples of the above-mentioned substituted or unsubstituted aryl group having 6 to 20 carbon atoms include phenyl group, naphthyl group, anthryl group, phenanthryl group, naphthacenyl group, and pyrenyl group.

Examples of the substituent of the aryl group and the styryl group include a halogen atom, hydroxyl group, the above-mentioned substituted or unsubstituted amino group, nitro group, cyano group, the above-mentioned substituted or unsubstituted alkyl group, the above-mentioned substituted or unsubstituted alkenyl group, the above-mentioned substituted or unsubstituted cycloalkyl group, the above-mentioned substituted or unsubstituted alkoxyl group, the above-mentioned substituted or unsubstituted aromatic hydrocarbon group, the above-mentioned substituted or unsubstituted aromatic heterocyclic group, the above-mentioned substituted or unsubstituted aralkyl group, the above-mentioned substituted or unsubstituted aryloxy group, the above-mentioned substituted or unsubstituted alkoxycarbonyl group, and carboxyl group.

Examples of a bivalent group forming a ring include tetramethylene group, pentamethylene group, hexamethylene group, diphenylmethan-2,2′-diyl group, diphenylethan-3,3′-diyl group, and diphenylpropan-4,4′-diyl group.

The compound represented by general formula [I] can be prepared by conventional methods. For example, a tetraphenylene compound having a diphenylamino group can be prepared by the Ullmann reaction between an amine compound with a tetraphenylene unit and an aromatic halogen compound, or between a halogen compound with a tetraphenylene unit and an aromatic amine compound. The styryl derivative can be prepared by the Wittig-Horner reaction.

Examples of the compound represented by formula [I] are as follows:

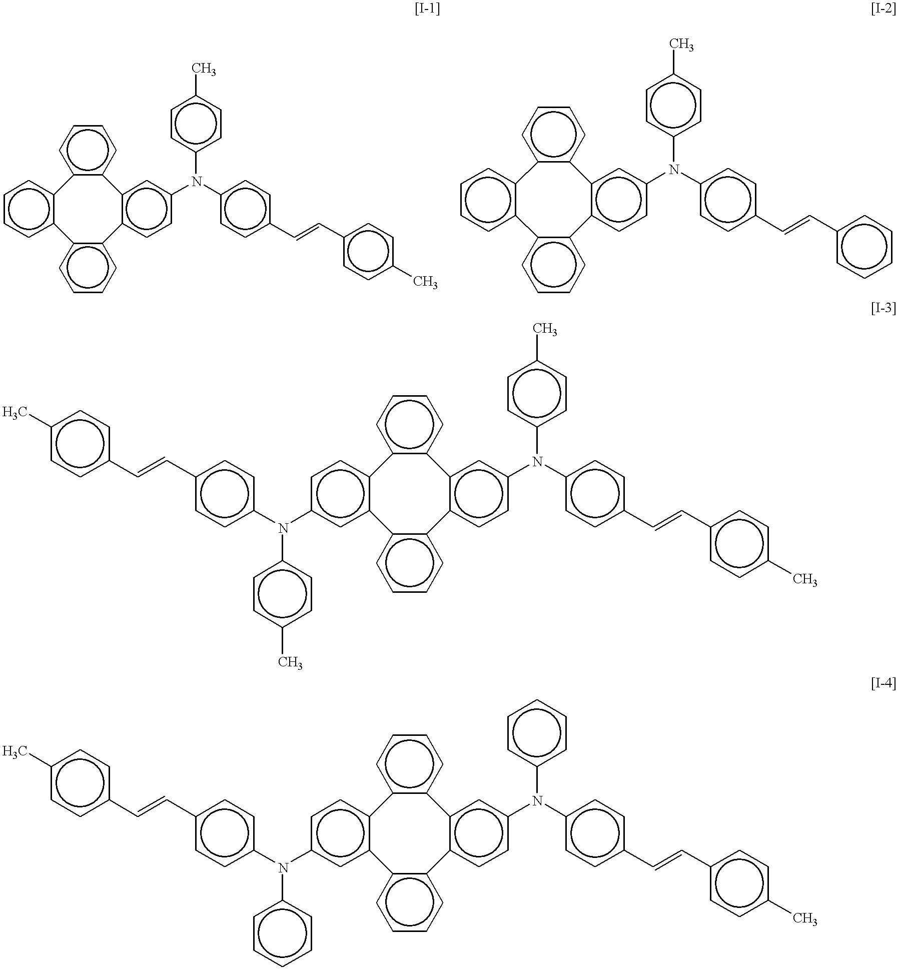

The compound of formula [I] is not limited to the above-mentioned specific examples in the present invention.

The hole-transporting material for use in the hole-transporting layer 3 is not particularly limited. In addition to the compound of formula [I], any known hole-transporting materials are usable for the hole-transporting layer 3. Examples of the conventional hole-transporting materials include triphenyldiamines such as bis(di(p-tolyl)aminophenyl)-1,1-cyclohexane, which will be represented by the following formula [01], N,N′-diphenyl-N,N′-bis(3-methylphenyl)-1,1′-biphenyl-4,4′-diamine, which will be represented by the following formula [02], and N,N′-diphenyl-N-N-bis(1-naphthyl)-1,1′-biphenyl)-4,4′-diamine, which will be represented by the following formula [03]; and star burst molecules, which will be represented by the following formulas [04] to [06].

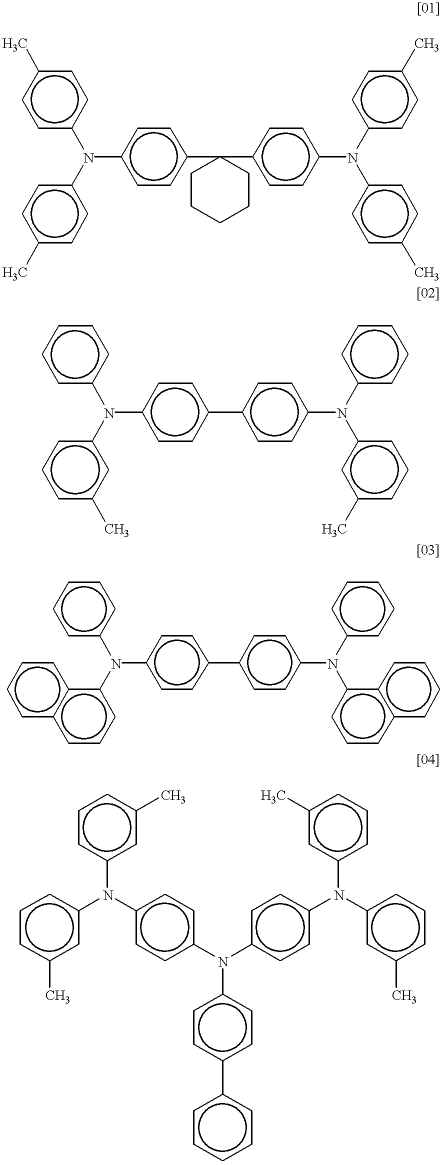

The light emitting material for use in the light emitting layer 4 is not particularly limited. In addition to the compound of formula [I], any conventional light emitting materials can be used for the light emitting layer 4. Specific examples of the conventional light emitting materials include a chelate complex such as tris (8-quinolinolate);aluminum complex, coumnarin derivatives, tetraphenylbutadiene derivatives, bisstyrylarylene derivatives, oxadiazole derivatives, and diphenylaminoarylene derivatives.

The electron-transporting material for use in the electron-transporting layer 5 is not particularly limited. In addition to the compound of formula [I], any conventional electron-transporting materials are usable for the electron-transporting layer 5. Specific examples of the conventional electron-transporting materials include oxadiazole derivatives such as 2-( 4-biphenylyl)-5-( 4-t-butylphenyl)-1,3,4-oxadiazole, which will be represented by the following formula [07], and bis( 2-( 4-t-butylphenyl)-1,3,4-oxadiazole)-m-phenylene, which will be represented by the following formula [08]; and triazole derivatives of the following formulas [09] and [10].

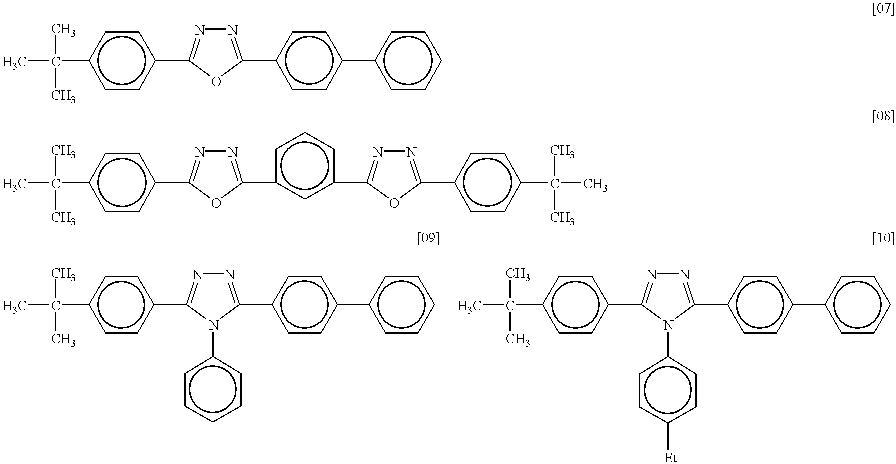

Further, as the electron-transporting material, there can be employed quinolinol-based metal complex compounds represented by the following general formulas [IV], [V] and [VI]:

(Q)ₙ−M [IV]

wherein Q represents a substituted or unsubstituted hydroxyquinoline derivative, or a substituted or unsubstituted benzoquinoline derivative, M represents a metal atom, and n represents the valence of the above-mentioned metal;

(Q)ₙ₋₁-M-O-L [V]

wherein Q represents a substituted or unsubstituted hydroxyquinoline derivative, or a substituted or unsubstituted benzoquinoline derivative, L represents a halogen atom, a substituted or unsubstituted alkyl group, a substituted or unsubstituted cycloalkyl group, or a substituted or unsubstituted aryl group which may contain a nitrogen atom, M represents a metal atom, and n represents the valence of the above-mentioned metal; and

(Q)ₙ₋₁-M-O-M-(Q)ₙ₋₁ [VI]

wherein Q represents a substituted or unsubstituted hydroxyquinoline derivative, or a substituted or unsubstituted benzoquinoline derivative, M represents a metal atom, and n represents the valence of the above-mentioned metal.

Specific examples of the compound represented by formula [IV] include the following compounds of formulas [11] to [16]:

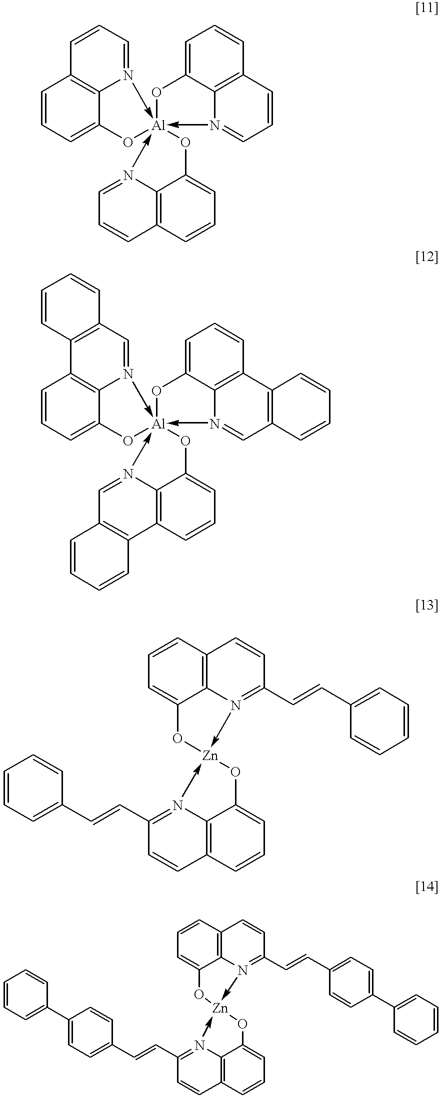

Specific examples of the compound represented by formula [V] include the following compounds of formulas [17] to [ 22]:

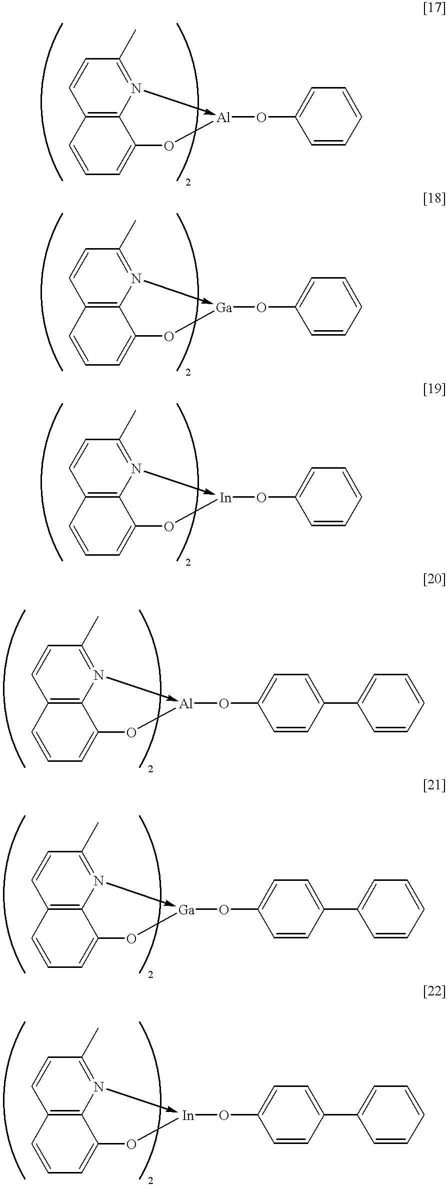

Specific examples of the compound represented by formula [VI] include the following compounds of formulas [23] to [25]:

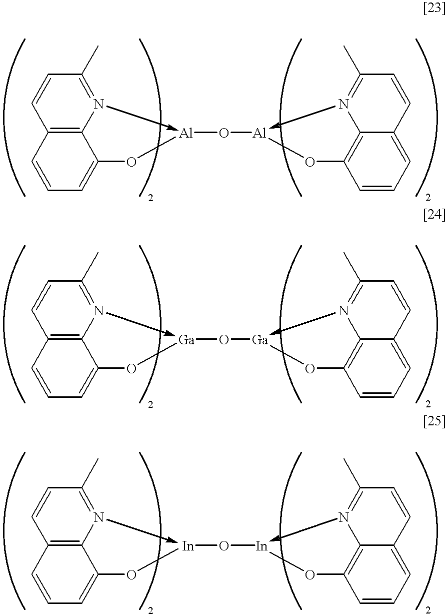

When the organic light emitting band is constituted of a plurality of organic thin film layers, the organic thin film layer situated adjacent to the anode comprises the compound represented by formula [I]. In this case, a light emitting layer may be interposed between the above-mentioned organic thin film layer comprising the compound of formula [I] and the cathode. Alternatively, a plurality of organic thin film layers comprising the specific compounds of formulas [I-1] to [I-6] may be appropriately interposed. Furthermore, between the light emitting layer situated adjacent to the anode and the cathode, there may be disposed a light emitting layer comprising a mixture of the electron-transporting material represented by any of the formulas [07] to [25] and the compound represented by any of the following formulas [ 26] to [29], or a light emitting layer comprising an electron-transporting and light-emitting material represented by the following formula [ 30]. Thus, the organic light emitting band may comprise a plurality of organic light emitting layers.

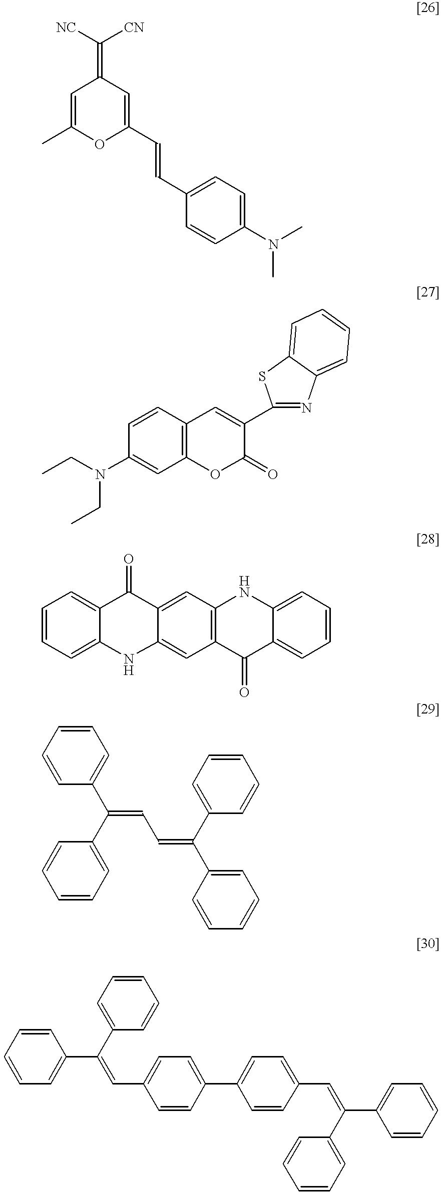

The anode 2 of the organic EL device according to the present invention, which serves to inject holes into the hole-transporting layer 3, may advantageously have a work function of 4.5 eV or more.. Specific examples of the materials for the anode include indium tin oxide (ITO), tin oxide (NESA), gold, silver, platinum, and copper.

The cathode 6 works to inject electrons into the electron-transporting layer 5 or the light emitting layer 4. It is preferable to employ a material with a small work function for the cathode. Specific examples of the materials for the cathode include indium, aluminum, magnesium, magnesium-indium alloy, magnesium-aluminum alloy, aluminum-lithium alloy, aluminum-scandium-lithium alloy, and magnesium-silver alloy. The materials for the cathode are not limited to the above-mentioned examples.

The method for forming each layer for use in the organic EL device of the present invention is not particularly limited. The conventional methods of vacuum deposition and spin coating are applicable. The organic thin film layer containing the compound of formula [I] can be formed by any conventional methods, for example, vacuum deposition, molecular beam epitaxy (MBE), and coating method using a solution of the compound [I] such as dip coating, spin coating, cast coating, bar coating, or roll coating.

The thickness of each organic thin film layer for use in the organic EL device of the present invention is not particularly limited, but preferably within the range of several nanometers to one micrometer. Too thin organic thin film layers may cause defects such as pin-holes. On the other hand, extremely thick organic thin film layers need a high applied voltage, thereby decreasing the efficiency.

Other features of this invention will become apparent in the course of the following description of exemplary embodiments, which are given for illustration of the invention and are not intended to be limiting thereof.

Synthesis Example 1 shown below is one embodiment indicating the method of synthesizing a compound represented by formula [ 1]. Other compounds represented by formula [I] were synthesized by the conventional method.

### Synthesis Example 1

Tetraphenylene and N-bromosuccinimide were placed in a mixed solvent of water and sulfuric acid (4:1), and stirred at 6020 C. for 5 hours. The thus obtained reaction mixture was extracted with toluene, and the resultant toluene layer was neutralized with a 5% aqueous solution of sodium hydrogencarbonate. After dried over magnesium sulfate, the toluene component was distilled away, so that a crude crystal was obtained.

The crude crystal thus obtained was recrystallized from a mixed solvent of toluene and hexane, whereby 2-bromotetraphenylene was synthesized.

The above-mentioned 2-bromotetraphenylene, 4-( 4-methylstyryl)phenyl-p-tolylamine, potassium carbonate, and copper powder were placed in a three neck distillation flask. The resultant mixture was stirred at 20020 C. for 30 hours. After completion of the reaction, the resultant mixture was extracted with toluene. The toluene layer was washed with water, and dried over magnesium sulfate, and the remaining solvent component was thereafter distilled away. The residue was chromatographed on silica gel and eluted with a mixed solvent of toluene and hexane ( 1:2), whereby 2-( 4-( 4-methylstyryl)phenyl-p-tolylamino)tetraphenylene [I-1] was synthesized.

The organic EL devices according to the present invention were fabricated by using the compound of formula [I] in various ways as shown in Examples 1 to 15. Namely, the compound of formula [I] was used for a light emitting layer in Examples 1 to 7; a mixture of the compound of formula [I] and a hole-transporting material was prepared into a thin film of light emitting layer in Examples 8 to 10; a mixture of the compound of formula [I] and an electron-transporting material was prepared into a thin film of light emitting layer in Examples 11 and 12; the compound of formula [I] was used for a hole-transporting layer in Examples 13 and 14; and the compound of formula [I] was used for an electron-transporting layer in Example 15.

### Example 1

The cross-section of an organic EL device according to Example 1 is shown in FIG. 1. Namely, an anode 2, a light emitting layer 4, and a cathode 6 are successively provided on a substrate 1 in the organic EL device of Example 1.

The organic EL device was fabricated by following the procedure shown below.

ITO (indium tin oxide) was deposited on a glass substrate 1 by sputtering, so that an anode 2 with a sheet resistivity of 20 Ω/□ was provided on the substrate 1.

The compound [I-1] was vacuum-deposited on the anode 2, so that a light emitting layer 4 with a film thickness of 40 nm was provided on the anode 2.

An alloy of magnesium and silver was vacuum-deposited on the light emitting layer 4, whereby a cathode 6 with a film thickness of 200 nm was provided on the light emitting layer 4.

Thus, an organic EL device No. 1 according to the present invention was fabricated.

When a direct-current voltage of 5 V was applied to the organic EL device No. 1, light emission of 1000 cd/m² was obtained.

### Example 2

The procedure for fabrication of the organic EL device No. 1 in Example 1 was repeated except that the compound [I-1] for use in the light emitting layer 4 in Example 1 was replaced by the compound [I-2].

Thus, an organic EL device No. 2 according to the present invention was fabricated.

When a direct-current voltage of 5 V was applied to the organic EL device No. 2, light emission of 1000 cd/m² was obtained.

### Example 3

The procedure for fabrication of the organic EL device No. 1 in Example 1 was repeated except that vacuum-deposition of the compound [I-1] as employed in Example 1 was replaced by spin-coating of a chloroform solution of the compound [I-1] for the formation of the light emitting layer 4 on the anode 2.

Thus, an organic EL device No. 3 according to the present invention was fabricated.

When a direct-current voltage of 5 V was applied to the organic EL device No. 3, light emission of 1200 cd/m² was obtained.

### Example 4

The cross-section of an organic EL device according to Example 4 is shown in FIG. 2. Namely, an anode 2, a hole-transporting layer 3, a light emitting layer 4, an electron-transporting layer 5, and a cathode 6 are successively provided on a substrate 1 in the organic EL device of Example 4.

The organic EL device was fabricated by following the procedure shown below.

ITO was deposited on a glass substrate 1 by sputtering, so that an anode 2 with a sheet resistivity of 20 Ω/□ was provided on the substrate 1.

N,N′-diphenyl-N,N′-bis(3-methylphenyl)-[1,1′-biphenyl]-4,4′-diamine [02] was vacuum-deposited on the anode 2, so that a hole-transporting layer 3 with a film thickness of 50 nm was provided on the anode 2.

Then, the compound [I-3] was vacuum-deposited on the hole-transporting layer 3, so that a light emitting layer 4 with a film thickness of 40 nm was provided on the hole-transporting layer 3.

2-(4-biphenylyl)-5-(4-t-butylphenyl)-1,3,4-oxadiazole [07] was vacuum-deposited on the light emitting layer 4, so that an electron-transporting layer 5 with a film thickness of 20 nm was provided on the light emitting layer 4.

An alloy of magnesium and silver was vacuum-deposited on the electron-transporting layer 5, whereby a cathode 6 with a film thickness of 200 nm was provided on the electron-transporting layer 5.

Thus, an organic EL device No. 4 according to the present invention was fabricated.

When a direct-current voltage of 10 V was applied to the organic EL device No. 4, light emission of 5500 cd/m² was obtained.

### Example 5

The procedure for fabrication of the organic EL device No. 4 in Example 4 was repeated except that N,N′-diphenyl-N,N′-bis(3-methylphenyl)-[1,1′-biphenyl]-4,4′-diamine [02] for use in the hole-transporting layer 3 in Example 4 was replaced by N,N′-diphenyl-N-N-bis(1-naphthyl)-1,1′-biphenyl)-4,4′-diamine [03], that the compound [I-3] for use in the light emitting layer 4 in Example 4 was replaced by the compound [I-4], and that 2-(4-biphenylyl)-5-(4-t-butylphenyl)-1,3,4-oxadiazole [07] for use in the electron-transporting layer 5 in Example 4 was replaced by bis {2-(4-t-butylphenyl)-1,3,4-oxadiazole}-m-phenylene [08].

Thus, an organic EL device No. 5 according to the present invention was fabricated.

When a direct-current voltage of 10 V was applied to the organic EL device No. 5, light emission of 6000 cd/m² was obtained.

### Example 6

The procedure for fabrication of the organic EL device No. 4 in Example 4 was repeated except that the compound [02] for use in the hole-transporting layer 3 in Example 4 was replaced by the compound [04], that the compound [I-3] for use in the light emitting layer 4 in Example 4 was replaced by the compound [I-5], and that the compound [07] for use in the electron-transporting layer 5 in Example 4 was replaced by the compound [11].

Thus, an organic EL device No. 6 according to the present invention was fabricated.

When a direct-current voltage of 10 V was applied to the organic EL device No. 6, light emission of 6800 cd/m² was obtained.

### Example 7

The procedure for fabrication of the organic EL device No. 4 in Example 4 was repeated except that the compound [02] for use in the hole-transporting layer 3 in Example 4 was replaced by the compound [05], that the compound [I-3] for use in the light emitting layer 4 in Example 4 was replaced by the compound [I-6], and that the compound [07] for use in the electron-transporting layer 5 in Example 4 was replaced by the compound [12].

Thus, an organic EL device No. 7 according to the present invention was fabricated.

When a direct-current voltage of 10 V was applied to the organic EL device No. 7, light emission of 7000 cd/m² was obtained.

### Example 8

The cross-section of an organic EL device according to Example 8 is shown in FIG. 4. Namely, an anode 2, a light emitting layer 4, an electron-transporting layer 5, and a cathode 6 are successively provided on a substrate 1 in the organic EL device of Example 8.

The organic EL device was fabricated by following the procedure shown below.

ITO was deposited on a glass substrate 1 by sputtering, so that an anode 2 with a sheet resistivity of 20 Ω/□ was provided on the substrate 1.

A mixture of N,N′-diphenyl-N-N-bis(1-naphthyl)-1,1′-biphenyl)-4,4′-diamine [03] and the compound [I-1] with a ratio by weight of 1:10 was deposited on the anode 2, so that a light emitting layer 4 with a film thickness of 50 nm was provided on the anode 2.

The compound [09] was vacuum-deposited on the light emitting layer 4, so that an electron-transporting layer 5 with a film thickness of 50 nm was provided on the light emitting layer 4.

An alloy of magnesium and silver was vacuum-deposited on the electron-transporting layer 5, whereby a cathode 6 with a film thickness of 200 nm was provided on the electron-transporting layer 5.

Thus, an organic EL device No. 8 according to the present invention was fabricated.

When a direct-current voltage of 10 V was applied to the organic EL device No. 8, light emission of 5200 cd/m² was obtained.

### Example 9

The procedure for fabrication of the organic EL device No. 8 in Example 8 was repeated except that the compound [I-1] for use in the light emitting layer 4 in Example 8 was replaced by the compound [I-3].

Thus, an organic EL device No. 9 according to the present invention was fabricated.

When a direct-current voltage of 10 V was applied to the organic EL device No. 9, light emission of 5300 cd/m² was obtained.

### Example 10

ITO was deposited on a glass substrate 1 by sputtering, so that an anode 2 with a sheet resistivity of 20 Ω/□ was provided on the substrate 1.

A chloroform solution containing a mixture of the compound [I-3] and N,N′-diphenyl-N-N-bis(1-naphthyl)-1,1′-biphenyl)-4,4′-diamine [03] with a molar ratio of 1:10 was spin-coated on the anode 2, so that a light emitting layer 4 with a film thickness of 40 nm was provided on the anode 2.

The compound [10] was vacuum-deposited on the light emitting layer 4, so that an electron-transporting layer 5 with a film thickness of 50 nm was provided on the light emitting layer 4.

An alloy of magnesium and silver was vacuum-deposited on the electron-transporting layer 5, whereby a cathode 6 with a film thickness of 200 nm was provided on the electron-transporting layer 5.

Thus, an organic EL device No. 10 according to the present invention was fabricated.

When a direct-current voltage of 10 V was applied to the organic EL device No. 10, light emission of 4300 cd/m² was obtained.

### Example 11

The cross-section of an organic EL device according to Example 11 is shown in FIG. 3. Namely, an anode 2, a hole-transporting layer 3, a light emitting layer 4, and a cathode 6 are successively provided on a substrate 1 in the organic EL device of Example 11.

The organic EL device was fabricated by following the procedure shown below.

ITO was deposited on a glass substrate 1 by sputtering, so that an anode 2 with a sheet resistivity of 20 Ω/□ was provided on the substrate 1.

N,N′-diphenyl-N-N-bis(1-naphthyl)-1,1′-biphenyl)-4,4′-diamine [03] was vacuum-deposited on the anode 2, so that a hole-transporting layer 3 with a film thickness of 50 nm was provided on the anode 2.

A mixture of the compound [11] and the compound [I-1] with a ratio by weight of 20:1 was vacuum-deposited on the hole-transporting layer 3, so that a light emitting layer 4 with a film thickness of 50 nm was provided on the hole-transporting layer 3.

An alloy of magnesium and silver was vacuum-deposited on the light emitting layer 4, whereby a cathode 6 with a film thickness of 200 nm was provided on the light emitting layer 4.

Thus, an organic EL device No. 11 according to the present invention was fabricated.

When a direct-current voltage of 10 V was applied to the organic EL device No. 11, light emission of 4500 cd/m² was obtained.

### Example 12

The procedure for fabrication of the organic EL device No. 11 in Example 11 was repeated except that N,N′-diphenyl-N-N-bis(1-naphthyl)-1,1′-biphenyl)-4,4′-diamine [03] for use in the hole-transporting layer 3 in Example 11 was replaced by N,N′-diphenyl-N,N′-bis(3-methylphenyl)-[ 1,1′-biphenyl]-4,4′-diamine [02], and that the mixture of the compounds [11] and [I-1] for use in the light emitting layer 4 in Example 11 was replaced by a mixture of the compound [13] and the compound [I-3].

Thus, an organic EL device No. 12 according to the present invention was fabricated.

When a direct-current voltage of 10 V was applied to the organic EL device No. 12, light emission of 3700 cd/m² was obtained.

### Example 13

The procedure for fabrication of the organic EL device No. 11 in Example 11 was repeated except that N,N′-diphenyl-N-N-bis(1-naphthyl)-1,1′-biphenyl)-4,4′-diamine [03] for use in the hole-transporting layer 3 in Example 11 was replaced by the compound [I-3], and that the mixture of the compounds [11] and [I-1] for use in the light emitting layer 4 in Example 11 was replaced by the compound [13].

Thus, an organic EL device No. 13 according to the present invention was fabricated.

When a direct-current voltage of 10 V was applied to the organic EL device No. 13, light emission of 4000 cd/m² was obtained.

### Example 14

The procedure for fabrication of the organic EL device No. 11 in Example 11 was repeated except that N,N′-diphenyl-N-N-bis(1-naphthyl)-1,1′-biphenyl)-4,4′-diamine [03] for use in the hole-transporting layer 3 in Example 11 was replaced by the compound [I-5].

Thus, an organic EL device No. 14 according to the present invention was fabricated.

When a direct-current voltage of 10 V was applied to the organic EL device No. 14, light emission of 4500 cd/m² was obtained.

### Example 15

The procedure for fabrication of the organic EL device No. 4 in Example 4 was repeated except that N,N′-diphenyl-N,N′-bis(3-methylphenyl)-[1,1′-biphenyl]-4,4′-diamine [02] for use in the hole-transporting layer 3 in Example 4 was replaced by N,N′-diphenyl-N-N-bis(1-naphthyl)-1,1′-biphenyl)-4,4′-diamine [03], that the compound [I-3] for use in the light emitting layer 4 in Example 4 was replaced by the compound [13], and that 2-(4-biphenylyl)-5-(4-t-butylphenyl)-1,3,4-oxadiazole [07] for use in the electron-transporting layer 5 in Example 4 was replaced by the compound [I-4].

Thus, an organic EL device No. 15 according to the present invention was fabricated.

When a direct-current voltage of 10 V was applied to the organic EL device No. 15, light emission of 2500 cd/m² was obtained.

(Half-value period of luminance)

Each of the organic EL devices fabricated in Examples 1 to 15 was controlled so that the initial luminance was 100 cd/m². Any organic EL devices showed a half-value period of luminance of 5000 hours or more when continuously driven.

Japanese Patent Application No. 11-353676 filed Dec. 13, 1999 is hereby incorporated by reference.

What is claimed is:

1. An organic electroluminescent device comprising one or more organic thin film layer(s) placed between an anode and a cathode, at least one of said layer being a luminescent layer, characterized in that said luminescent layer comprises a compound expressed in following general formula [I] in the form of a single substance or a mixture containing the same. 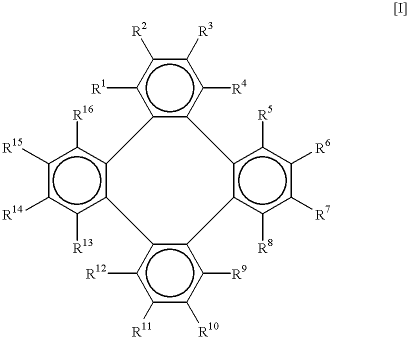
wherein each of R¹ to R¹⁶ independently represent a hydrogen atom, a halogen atom, hydroxyl group, a substituted or unsubstituted amino group, nitro group, cyano group, a substituted or unsubstituted alkyl group, a substituted or unsubstituted alkenyl group, a substituted or unsubstituted cycloalkyl group, a substituted or unsubstituted alkoxyl group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group, or carboxyl group, provided that at least one of R¹ to R¹⁶ is a group represented by -NAr ¹Ar² wherein each of Ar¹ and Ar² independently represent a substituted or unsubstituted aryl group having 6 to 20 carbon atoms, and at least one of Ar¹ or Ar² has a substituted or unsubstituted styryl group, and that two of R¹ to R¹⁶ may form a ring.

2. The organic electroluminescent device according to claim 1, wherein said at least one organic thin film layer comprising said compound represented by general formula [I] is a light emitting layer.

3. The organic electroluminescent device according to claim 1, wherein said at least one organic thin film layer comprising said compound represented by general formula [I] is a hole-transporting layer.

4. The organic electroluminescent device according to claim 1, wherein said at least one organic thin film layer comprising said compound represented by general formula [I] is an electron-transporting layer.

5. An organic electroluminescent device comprising at least an anode, a luminescent zone and a cathode, the luminescent zone being formed one or more organic thin film layer(s), characterized in that said luminescent zone is adjacent to the anode, and a layer adjacent to the anode of the organic layer(s) forming the luminescent zone contains a compound expressed in following general formula [I] in the form of a single substance or a mixture containing the same. 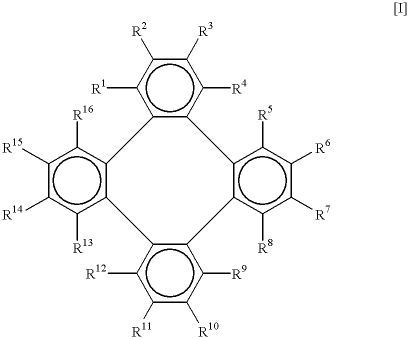
wherein each of R¹ to R¹⁶ independently represent a hydrogen atom, a halogen atom, hydroxyl group, a substituted or unsubstituted amino group, nitro group, cyano group, a substituted or unsubstituted alkyl group, a substituted or unsubstituted alkenyl group, a substituted or unsubstituted cycloalkyl group, a substituted or unsubstituted alkoxyl group, a substituted or unsubstituted aromatic hydrocarbon group, a substituted or unsubstituted aromatic heterocyclic group, a substituted or unsubstituted aralkyl group, a substituted or unsubstituted aryloxy group, a substituted or unsubstituted alkoxycarbonyl group, or carboxyl group, provided that at least one of R¹ to R¹⁶ is a group represented by -NAr¹Ar² wherein each of Ar¹ and Ar² independently represent a substituted or unsubstituted aryl group having 6 to 20 carbon atoms, and at least one of Ar¹ or Ar² has a substituted or unsubstituted styryl group, and that two of R¹ to R¹⁶ may form a ring.
